(19) United States
(12) Patent Application Publication
(10) Pub. No.: US 2007/0012855 A1
(43) Pub. Date: Jan. 18, 2007

(54) Shelf components

(76) Inventor: Ted Rocavert, Willoughby (AU)

Correspondence Address: MICHAEL MOLINS;MOLINS & CO., SUITE 5, LEVEL 6, 139 MACQUARIE ST, SYDNEY NSW, 2000, AU

(21) Appl. No.: 11/450,549

(22) Filed: Jun. 12, 2006

(30) Foreign Application Priority Data
Jun. 30, 2005 (AU) 2005903449

(51) Int. Cl. F16M 7/00

(52) U.S. Cl. 248/674

(57) ABSTRACT

A bracket is fabricated from metal wire. The wire is bent to form a closed loop that includes at least an “L” shaped portion characterised by an arrangement of spaced apart and generally parallel wires. In preferred embodiments, the parallel wires forming the loop have located between them a threaded nut that is adapted to receive an adjustment bolt or threaded fastener. The fastener or alternately the adjustment bolts can be used to either to level the device or maintain a fixed spacing with respect to a wall or other structural element. The bracket is also adapted to receive a retaining clip that can be used with window boxes.

### FIELD OF THE INVENTION

The invention pertains to shelf support components and but more particularly to supporting brackets and accessories primarily intended for the support of flowerpots and planter or window boxes.

### OBJECTS AND SUMMARY OF THE INVENTION

It is an object of the invention to provide a versatile system that is intended primarily for outdoor use. The system is adapted to support a shelf or a planter or window box such that it is suspended from a wall, fence, railing, balcony or other supporting structure. The system proposes to utilize materials primarily metal wire, in an efficient way. This minimal or optimized use of materials has a beneficial impact on the cost of the product as well as creating an aesthetically pleasing design, particularly one that is not intrusive.

Accordingly, there is provided a bracket fabricated from metal wire. The wire is bent to form a closed loop that includes at least an “L” shaped portion characterised by an arrangement of spaced apart and generally parallel wires. In preferred embodiments, the parallel wires forming the loop have located between them a threaded nut that is adapted to receive an adjustment bolt or threaded fastener. The fastener or alternately the adjustment bolts can be used to either to level the device or maintain a fixed spacing with respect to a wall or other structural element. The bracket is also adapted to receive a retaining clip that can be used with window boxes. Various embodiments are proposed.

### BRIEF DESCRIPTION OF THE DRAWING FIGURES

In order that the invention be better understood, references now made to the following drawing figures in which:

FIG. 1 is an exploded perspective of a first embodiment of the shelf components disclosed here in;

FIG. 2 is a perspective view of the device depicted in FIG. 1;

FIG. 3 is a second embodiment of the device depicted in FIGS. 1 and 2, illustrating an alternate upper end;

FIG. 4 depicts a third embodiment having a different style upper end for wall attachments;

FIG. 5 is a side elevation illustrating how a window box is affixed;

FIGS. 6 (a) and (b) show alternate embodiments of a retaining bracket;

FIG. 7 is a side elevation, illustrating how the device may be retained against a railing structure;

FIG. 8 is a perspective view illustrating the use of a retaining bar and suggesting the utilization of other accessories;

FIG. 9 is a top plan view of a retaining bar as suggested by FIG. 8

FIG. 10 is a perspective view of the embodiment suggested by FIG. 4;

FIG. 11 is a perspective view of the shelf unit having three removable shelves;

FIG. 12 is a detail taken from FIG. 11, illustrating how the shelves interlock with the side panels;

FIG. 13 is a perspective view of a shelf of the type utilized in FIGS. 11 and 12;

FIG. 14 is a side elevation of the shelf depicted in FIG. 13.

### BEST MODE AND OTHER EMBODIMENTS OF THE INVENTION

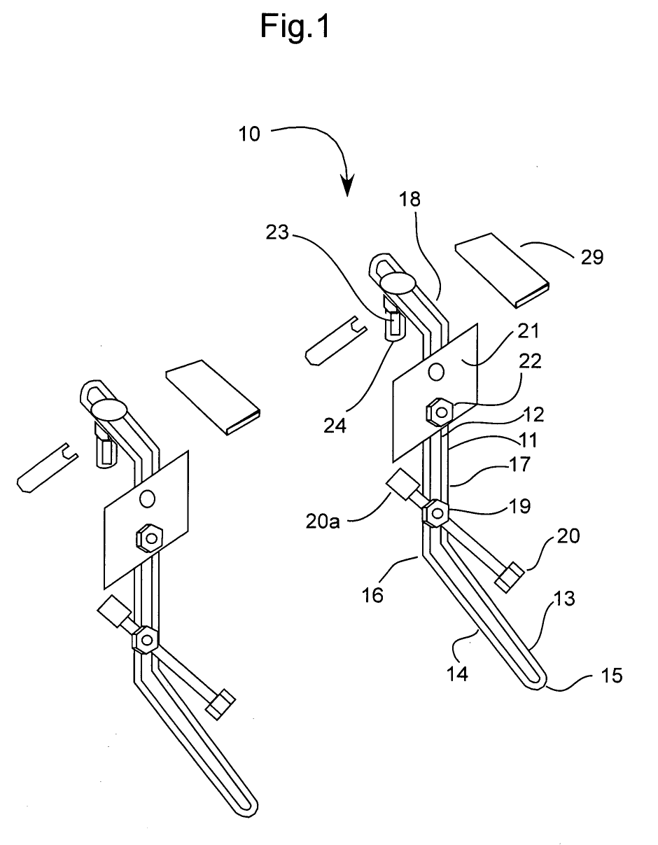

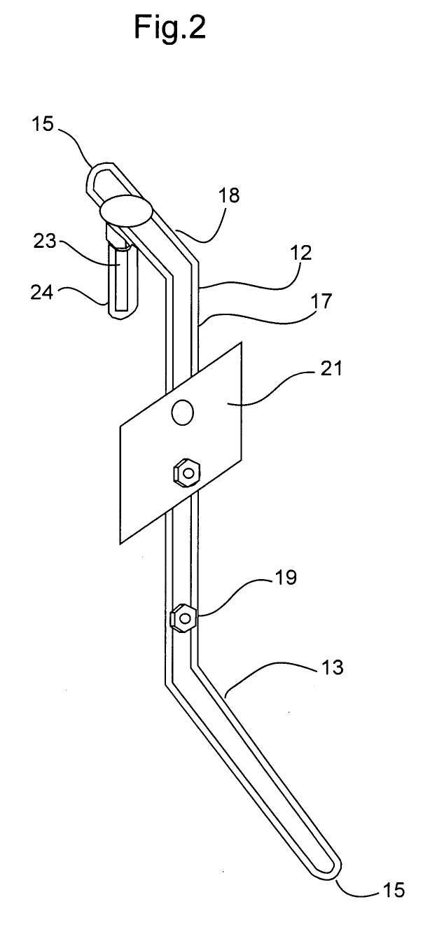

As shown in FIGS. 1 and 2, shelf supporting bracket components 10 are fabricated from i.e. 5 mm steel wires forming a body 11 and other hardware components. The primary body of each supporting bracket 12 is shown in this particular embodiment as having three primary co-joined segments. The body 11 is formed as a continuous loop of the wire. Each end of the body forms a “U” shaped bend of about 7 mm.

The first segment is the main shelf supporting segment 13 and thus comprises a pair of parallel steel wires 14 that are joined at their distal tips by a “U” shaped bend 15. The main purpose of this section is to support, from below, the base of a planter/window box or a supporting shelf on which flowerpots may be placed in which e.g. flowers may be planted. Where a wooden shelf is supported by and above the main shelf supporting segment 13 it may be attached by screws that pass between the parallel steel wires 14 into an underside of the shelf. Practically any type of shelf can be supported by the main horizontal segment 13.

The main horizontal segment 13 is connected by a ninety-degree or slightly less bend 16 to the main vertical section 17. This section is characterized by a pair of parallel, spaced apart, horizontal wires that extend between the main horizontal segment and the optional upper or adjustment section 18. The vertical section 17 of the body is characterized by a threaded nut 19 that is welded onto or between the parallel vertical members. The threaded nut 19 is adapted to receive, for example, a stand-off adjustment bolt 20 or a fastener for a bridging mechanism, as will be disclosed. Bolt 20 may carry a polymer tip 20a. The vertical section 17 may optionally carry a second threaded bolt (located behind the section 17 and not shown) to which may be affixed a retaining plate 21 that is affixed to the second nut 55 by a fastener 22.

The adjustment portion 18 (in this example) is generally parallel with the main horizontal support segment 13 (but extending in an opposite direction) and is adapted to carry an adjustable bumper or fastener 23. The fastener 23 can be tightened in any number of positions along the length of the adjustment portion 18 so as to clamp a rail or other horizontal supporting surface between a rubber tubular covering 24 carried by the fastener 23 and the vertical section 17.

Note in this example that an adjustment bolt 20 is threaded into the threaded nut 19 that is captive to the vertical section 17. That nut may optionally terminate in a bumper or pad 20a that is adapted to make contact with a wall, fence or panel. The pad 20a prevents the nut 20 from damaging the substrate to which it is attached. Flat rubber pads 29 maybe used beneath the adjustment portion 18 or other wise as required to prevent injury to the substrate.

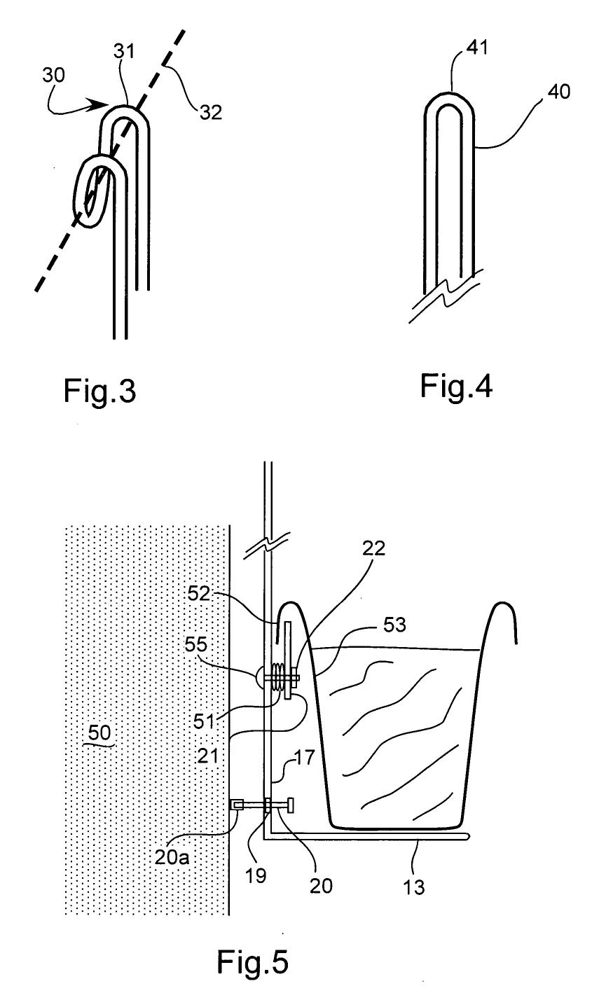

As shown in FIG. 3, the upper portion of the bracket may use a suspension hook arrangement 30 in place of the adjustment portion 18. As shown in this example, the wires that form the upper portion of the bracket 12 are bent to form a “U” shaped hook 31, in the same plane as the vertical section, that can be supported by, the edge 32 of a balcony, fence or other free edge.

As shown in FIGS. 4 and 10, the upper end 40 of a vertical portion of a bracket 12 can form a simple, flat “U” shaped 7 mm terminal bend 41 so that the bracket may be flush mounted onto a wall or fence.

As shown in FIG. 5, a mounting bracket 12 as disclosed above, can be mounted to a wide variety of structures. Note that the set-off or levelling bolt 20 is threaded through the fastener 19 so that the pad or cap 20a contacts a wall or other surface 50. The retaining clip 21 has been spaced away from the vertical section 17 by a number of washers 51 allowing for different window box lip widths. This creates a gap into which the lip 52 of a window box can be inserted and retained. Note that a removable bolt 55 carried by the vertical section is used to carry the retaining clip 21. This allows the location of the retaining clip 21 to be adjusted vertically so as to accommodate a variety of planter box or window box sizes. Thus, the window box 53 is supported from beneath from the horizontal segment 13 and is restrained by the gap formed between the retaining plate 21 and the vertical section 17. The horizontal segment 13 is maintained in a level orientation by the adjustment bolt 20.

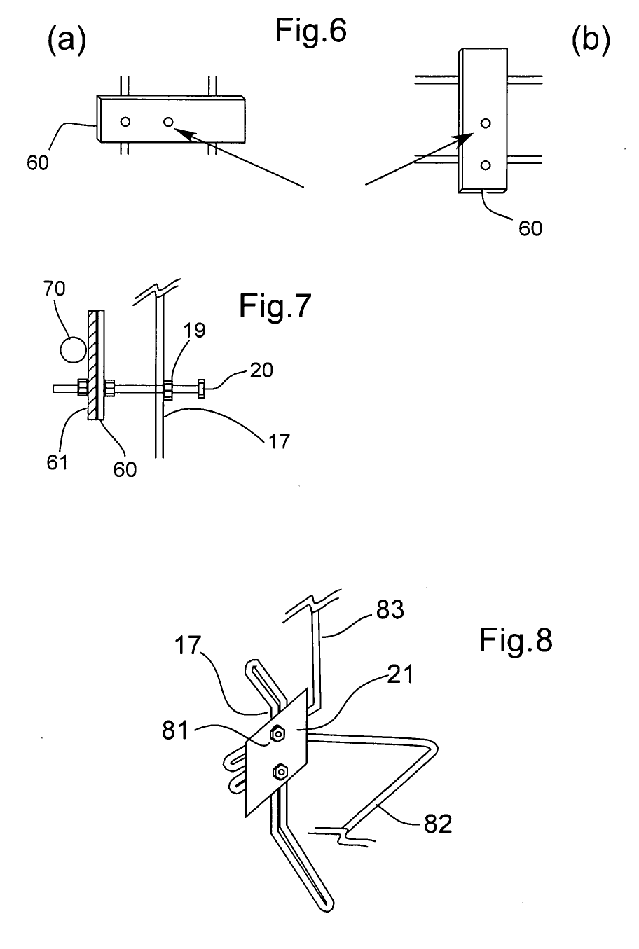

As shown in FIG. 6, an adjustment or bridging plate can be attached onto the end of a threaded fastener 20 carried by a nut welded to the bracket. As shown, the adjustment or bridging plate 60 can be used behind or in front of a structural feature such as a pair of adjacent railings. As better shown in FIG. 7, the railings 70 are effectively clamped or bridged between the adjustment plate 60 and the vertical section 17 by the action of the bolt 20 and fixed nut 19. Note that a thin rubber pad 61 maybe used between the adjustment plate 60 and the railing 70 to prevent scratching. Tightening or listening the adjustment bolt 20 has the effect of drawing the plate 60 closer or further away to the vertical section 17 allowing for a perfect horizontal level to be achieved for the flowerpots or box.

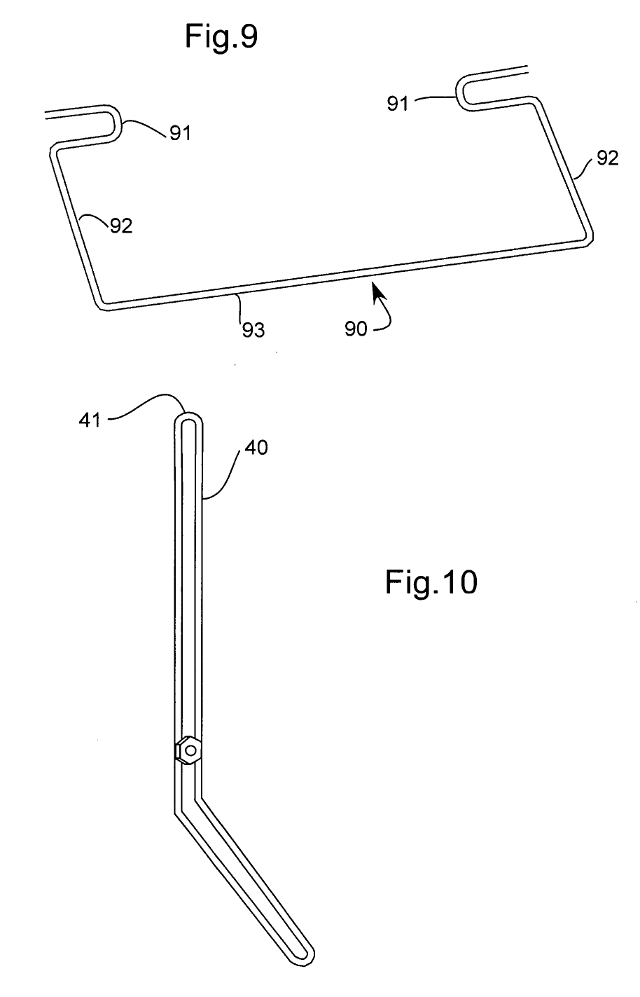

As shown in FIG. 8, the retaining plate 21 maybe provided with an additional opening so as to receive a second fastener 81. As shown in this example, accessories such as a pot restraining brace or arm 82 can be clamped between the retaining plate 21 and the vertical section 17. A second accessory such as a trellis for climbing plants or a bird or insect proof cover maybe retained by the second fastener 81. As shown in FIG. 9, the restraining arm 90 comprises a single piece of bent metal wire having “U” shaped terminal ends 91. The bent terminal “U” shaped ends 91 which are bent at 90° relative to the restraining arms 92 and 93, maybe retained between the plate and the vertical section as shown in 8, or bolted directly on to the vertical parallel wire. In this example the restraining arm 90 comprised side portions 92 of equal length, the side portions being interconnected by a longer extent of metal wire 93.

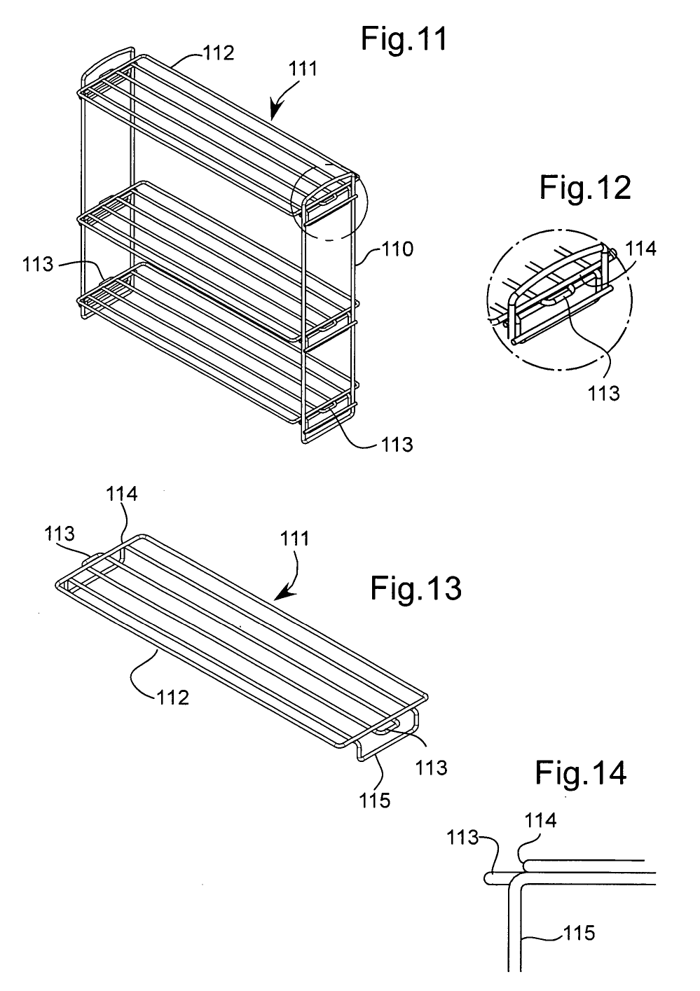

It is contemplated that the metal wire brackets disclosed above might be used in pairs, together with an interlocking and removable metal wire shelf. As shown in FIG. 11, metal wire shelves of this type maybe used together with the brackets disclosed, for example, in FIGS. 1-4 or can be used with side panels 110.

As shown in FIGS. 12-14, each shelf ill comprises a primary rectangular frame 112 forming a continuous perimeter. Small centrally located bumpers or ears 113 extend past the lateral edges 114 of the main frame and are formed together from a loop of metal wire that is longer than the main frame 114 but not as wide. Each shelf also incorporates a descending locking tab 115. Note that the locking tab is wider than the bumper portion 113 but not as wide as the main frame 114. The locking tab 115 is adapted to the inserted between the parallel wires of the bracket horizontal portion 13, or it maybe inserted into the appropriate gaps formed in the side panels as shown in FIG. 12. When welded together the shelf frame 112 and the bumper and tab component 113, 115 create a rigid and integral structure.

While the invention has been disclosed with reference to particular details of construction these should be understood as having been provided by way of example and not limitations to this scope or spirit of the invention.

What is claimed is:

1. A bracket comprising:
a steel wire body formed as a continuous loop having two ends, each end of ends of the body forming a “U” shaped bend;
the body having a first horizontal shelf supporting segment comprising a pair of parallel steel wires that are joined at their distal tips by one of the “U” shaped bends;
the horizontal segment connected by a bend to a vertical section comprising a pair of parallel, spaced apart, vertical wires that extend from the first segment;
the vertical section carrying a threaded nut that is attached to the vertical wires;
the threaded nut receiving a first adjustment bolt.

2. The bracket of claim 1, wherein:
the vertical section carries a movable threaded bolt to which is affixed a retaining plate that is affixed by a fastener.

3. The bracket of claim 1, wherein:
the body further comprises an adjustment portion extending from the vertical section, generally parallel with the horizontal support segment, but extending in an opposite direction.

4. The bracket of claim 3, wherein:
the adjustment portion if straight, is adapted to carry an adjustable fastener that can be tightened in any number of positions along a length of the adjustment portion so as to clamp a rail or other horizontal supporting surface between a the adjustable fastener and the vertical section.

5. The bracket of claim 1, wherein:
the first adjustment bolt terminates in a bumper or pad that is adapted to make contact with a wall, fence or panel.

6. The bracket of claim 3, wherein:
a flat pad is located beneath the adjustment portion to prevent injury to a substrate.

7. The bracket of claim 1, wherein:
an upper extent of the vertical section forms a suspension hook arrangement comprising a “U” shaped hook in the same plane as the vertical section.

8. The bracket of claim 1, further comprising:
a retaining clip supported by and spaced away from the vertical section forming a gap into which the lip of a window box can be inserted and retained.

9. The bracket of claim 8, wherein:
a removable bolt is carried behind the vertical section and is used to carry the retaining clip, allowing a location of the retaining clip to be adjusted vertically.

10. The bracket of claim 1, further comprising:
a bridging plate located behind the vertical section and attached to an end of a horizontal threaded fastener that is carried by a nut attached to the vertical section.

11. The bracket of claim 8, wherein:
the retaining plate is provided with an additional opening so as to receive a second fastener;
an accessory being clampable between the retaining plate and the vertical section and being retained by the second fastener.

12. The bracket of claim 11, wherein:
the accessory is a restraining arm comprising a single piece of bent metal wire having “U” shaped terminal ends that are retained between the retaining plate and the vertical section.

13. The bracket of claim 12, wherein:
the restraining arm comprised side portions of equal length, the side portions being interconnected by a longer extent of metal wire.

14. The bracket of claim 1, wherein:
the bracket is provided with a second similar bracket so that the two brackets can be used with an interlocking and removable metal wire shelf.

15. The bracket of claim 14, wherein:
the shelf comprises a primary rectangular frame forming a continuous perimeter having centrally located ears formed from a loop of metal wire that is longer than the rectangular frame but not as wide.

16. The bracket of claim 15, wherein:
each shelf also incorporates a descending locking tab that is wider than the ears but not as wide as the frame.
